(19) United States
(12) Patent Application Publication
(10) Pub. No.: US 2014/0064845 A1
(43) Pub. Date: Mar. 6, 2014

(54) FITTING BODY

(71) Applicant: RECARO Aircraft Seating GmbH & Co. KG., Schwabisch Hall (DE)

(72) Inventors: Kurt MUELLER, Ravensburg (DE); Alfons STACHEL, Rosengarten (DE); Jurgen BAUMANN, Bodman-Ludwigshafen (DE)

(73) Assignee: RECARO Aircraft Seating GmbH & Co. KG., Schwabish Hall (DE)

(21) Appl. No.: 14/011,876

(22) Filed: Aug. 28, 2013

(30) Foreign Application Priority Data
Aug. 31, 2012 (DE) 10 2012 108 120.4

(51) Int. Cl. F16S 5/00

(52) U.S. Cl. CPC F16S 5/00
USPC 403/404; 29/592; 72/253.1; 409/131

(57) ABSTRACT

A fitting body having at least one fitting unit is produced, at least to a large part, from a material having a density of less than 7000 kg/m³.

### PRIOR ART

The invention relates to a fitting body according to Claim 1.

There has already been proposed a fitting body having at least one fitting unit which is produced, at least to a large part, from a material having a density of more than 7000 kg/m³. The fitting unit is produced from steel having a density in a range from 7850-7870 kg/m³. In addition, the fitting unit produced from steel is produced in a forging process.

The object of the invention consists in providing a device of the type in question that has improved properties in terms of weight and manufacturing costs. The object is achieved according to the invention by the features of Patent Claim 1, while advantageous configurations and developments of the invention can be taken from the subclaims.

### Advantages of the Invention

What is proposed is a fitting body having at least one fitting unit which is produced, at least to a large part, from a material having a density of less than 7000 kg/m³. Alternatively, it is conceivable that the fitting unit is produced from a material of less than 5000 kg/m³. It is likewise conceivable that the fitting unit is produced from a material of less than 3500 kg/m³. A “fitting unit” is to be understood in particular as meaning a unit which is provided in at least one operating state for fastening a seat unit and/or for tying down loads on a floor, in particular on a floor of an aircraft. In particular, the fitting unit is held in the operating state in a recess in the floor, in particular in a guide rail in the floor. The fitting unit preferably has at least one fastening unit which comprises at least one fastening means. In particular, the fitting unit is mounted in the recess of the floor so as to be movable along a direction which is oriented at least substantially parallel to the floor. The fitting unit preferably has at least one coupling unit which is intended to allow the fastening of the seat unit and/or the tying down of loads on the floor. A “fastening means” is to be understood as meaning in particular a means which, in at least one operating state of the fitting unit, is intended to prevent a movement of the fitting unit in a direction oriented at least substantially parallel to the floor and/or in a direction oriented at least substantially perpendicularly to the floor. The expression that a straight line and/or plane is oriented “at least substantially parallel” to a further straight line and/or plane formed separately from the first-mentioned straight line and/or plane is to be understood as meaning in particular that the straight line and/or plane encloses with the further straight line and/or plane an angle which deviates by less than 5°, preferably by less than 3° and in particular by less than 1° from an angle of 0°. The expression that a straight line and/or plane is oriented “at least substantially perpendicularly” to a further straight line and/or plane formed separately from the first-mentioned straight line and/or plane is to be understood as meaning in particular that the straight line and/or plane encloses with the further straight line and/or plane an angle which deviates by less than 5°, preferably by less than 3° and in particular by less than 1° from an angle of 90°. A very lightweight fitting body can be advantageously achieved by means of a configuration according to the invention. In addition, a secure, stable fastening of a seat unit and/or a secure, stable tying down of loads on a floor can advantageously be achieved. Furthermore, it is possible to save on further components for fastening the seat unit and/or for tying down loads on the floor, with the result that weight and manufacturing costs can advantageously be additionally reduced.

It is further proposed that the fitting unit is produced, at least partially, in an extrusion process. Alternatively, it is conceivable that the fitting unit is produced, at least partially, by forging. It is also conceivable that the fitting unit is produced, at least partially, by casting. In particular, the fitting unit has, at least substantially, an extruded profile. An “extrusion process” is to be understood as meaning in particular a process for producing components, in particular for producing components with an irregular profile. In the extrusion process, in particular, a material body from which the fitting unit is produced is brought to a deformation temperature and pressed through a die which defines a shape and/or a profile of the fitting unit. In particular, after applying the extrusion method, in particular after pressing through the die, the material body has a shape which differs from a cylinder and/or from a cuboid. Essential structural features of the fitting unit can preferably be produced in the extrusion method. In particular, after applying the extrusion method, in particular after pressing through the die, the material body has essential structural features of the fitting unit. Segments are preferably cut to length, in particular sawn off, from the material body after application of the extrusion method, in particular after pressing through the die. In particular, the material body is stretched in the extrusion process, with the result that a strengthening of the material can advantageously be achieved. A structure direction of the material body after application of the extrusion method is preferably oriented counter to a load direction acting on the material body in a subsequent use state, with the result that it can be advantageously ensured that the material body breaks at a later time by comparison with an alternatively produced material body under otherwise identical conditions. In particular, a high degree of deformation and complicated shapes and/or profiles can be produced in the extrusion process. In particular, the extrusion process is suitable for metallic materials and/or alloys. The expression that the fitting unit is “produced, at least partially, in an extrusion process” is to be understood as meaning in particular that a method for producing the fitting unit comprises at least one method step in which an extrusion process is used. A configuration according to the invention makes it possible advantageously to achieve a fitting unit which can be produced simply and thus to reduce manufacturing costs. Furthermore, the fitting unit can advantageously be simply produced in an arbitrarily complicated form. In addition, a high degree of deformation can advantageously be achieved in a simple manner in a single extrusion process step.

Moreover, it is proposed that the fitting unit is produced, at least partially, from aluminum. In particular, the fitting unit is produced, at least partially, from high-strength aluminum. The fitting unit is preferably produced from an aluminum alloy, such as, for example, AW7055. Alternatively, the fitting unit is produced from an aluminum-lithium alloy, such as, for example, Al—Li 2099. Aluminum preferably has a density of, at least substantially, 2700 kg/m³. “At least substantially” is to be understood in particular as meaning in this context that a deviation from a predetermined value deviates in particular less than 25%, preferably less than 10% and particularly preferably less than 5% of the predetermined value. The expression that the fitting unit “is produced, at least partially, from aluminum” is to be understood as meaning in particular that the fitting unit is produced with a mass fraction of more than 75%, preferably of more than 80% and in particular of more than 85% of aluminum. A configuration according to the invention makes it advantageously possible to achieve a very lightweight fitting body.

Furthermore, it is proposed that the fitting unit is produced, at least partially, from titanium. In particular, the fitting unit is produced, at least partially, from high-strength titanium. Titanium preferably has a density of, at least substantially, 4507 kg/m³. “At least substantially” is to be understood as meaning in particular in this context that a deviation from a predetermined value deviates in particular less than 25%, preferably less 10% and particularly preferably less than 5% of the predetermined value. The expression that the fitting unit “is produced, at least partially, from titanium” is to be understood as meaning in particular that the fitting unit is produced with a mass fraction of more than 75%, preferably of more than 80% and in particular of more than 85% of titanium. A configuration according to the invention makes it advantageously possible to achieve a fitting body consisting of a very light material, with the result that weight can be advantageously reduced.

It is further proposed that the fitting unit is produced, at least partially, in a milling process. A “milling process” is to be understood as meaning in particular a process for machining a workpiece, in particular a workpiece consisting of metals, by means of a tool, in particular by means of a milling tool. In particular, the tool rotates relative to the fixed workpiece during the milling process, in particular relative to the workpiece clamped fixedly on a machine table, with the result that a cutting movement necessary for the machining is made possible. “Machining” is to be understood as meaning a processing operation after the application of which a workpiece is brought into a desired shape by removing the material. In particular, during machining, a tool, in particular a tool cutting edge, penetrates into a surface of the workpiece to be machined and strips a preferably thin, material layer from the surface of the workpiece to be machined. The expression that the fitting unit is “produced, at least partially, in a milling process” is to be understood as meaning in particular that a method for producing the fitting unit comprises at least one method step in which a milling process is used. A fitting unit which can be produced simply and inexpensively can be advantageously achieved by a configuration according to the invention. Furthermore, the fitting unit can be advantageously produced simply in an arbitrarily complicated form. Furthermore, material can advantageously be milled off and thus unnecessary weight can be reduced.

In addition, it is proposed that the fitting unit has a strength of greater than 650 N/mm². In particular, the fitting unit has an elongation at break in a range between 7% and 12%, preferably between 8% and 10%. A “strength” is to be understood as meaning in particular a property of a material which takes the form of a resistance, in particular a mechanical resistance, of the material against plastic deformation and/or separation. In particular, the strength takes the form of a tensile strength. A “tensile strength” is to be understood as meaning in particular a property of a material which are understood as a ratio of a maximum achievable tensile force on a workpiece manufactured from the material, preferably in a tensile test, to an original cross section of the workpiece manufactured from the material, in particular prior to an application of the tensile force, preferably before the start of the tensile test. A configuration according to the invention makes it possible advantageously to achieve a stable, secure fitting unit having a high strength, with the result that advantageously further components for stabilizing and/or for increasing the strength of the fitting unit can be spared and thus weight and manufacturing costs can be reduced.

Furthermore, a method for producing a fitting body according to the invention is proposed. A configuration according to the invention makes it possible advantageously to produce a fitting body reliably, simply, reproducibly and of high quality, with the result that manufacturing costs resulting from deficient production quality and associated remanufacturing can be saved. As a result, customer satisfaction can also be increased.

Further, it is proposed that the fitting unit is produced, at least partially, in an extrusion process. A configuration according to the invention makes it possible advantageously to achieve a fitting unit which can be produced simply and thus to reduce manufacturing costs. Furthermore, the fitting unit can advantageously be produced in a simple manner in an arbitrarily complicated shape. Moreover, a high degree of deformation can be simply achieved in a single extrusion process step.

Moreover, it is proposed that the fitting unit is produced, at least partially, in a milling process. A configuration according to the invention makes it possible advantageously to achieve a fitting unit which can be produced simply and inexpensively. Furthermore, the fitting unit can advantageously be produced simply in an arbitrarily complicated shape. Furthermore, undesired material can be advantageously milled off and thus unnecessary weight can be reduced.

### DRAWINGS

Further advantages will emerge from the following description of the drawings. An exemplary embodiment of the invention is illustrated in the drawings. The drawings, the description and the claims contain numerous features in combination. A person skilled in the art will also expediently consider the features individually and combine them into appropriate further combinations.

In the drawings:

FIG. 1 shows a detail of a fitting body according to the invention in a partially manufactured state, and

FIG. 2 shows the fitting body according to the invention from FIG. 1 in a manufactured state.

### DESCRIPTION OF THE EXEMPLARY EMBODIMENT

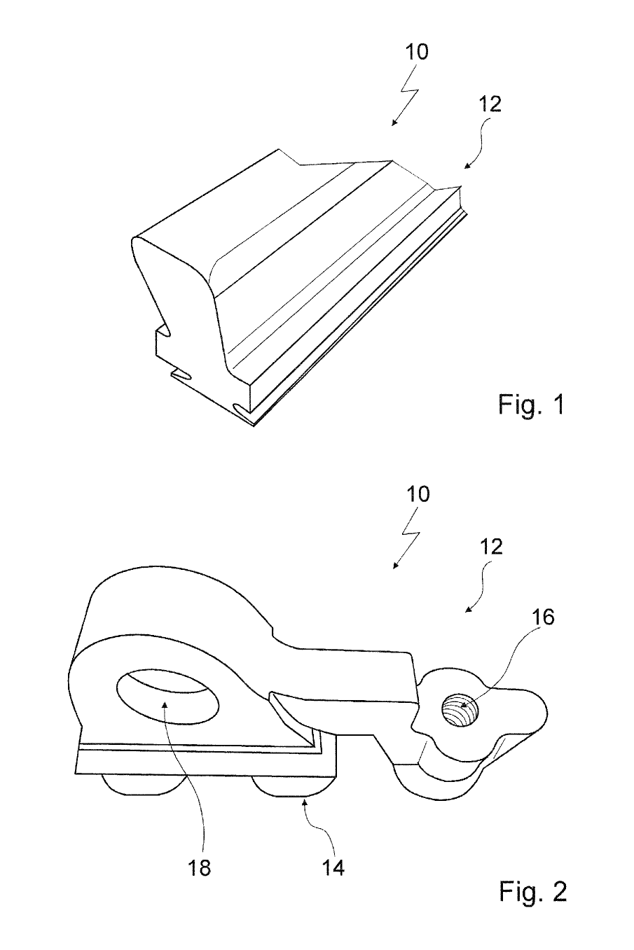

FIG. 1 shows a detail of a fitting body 10 in a partially manufactured state. The fitting body 10 is equipped with a fitting unit 12 which is produced to a large part from a material having a density of less than 7000 kg/m³. For example, the fitting unit 12 is produced from antimony, vanadium and/or zirconium. Also conceivable are further materials having a density of less than 7000 kg/m³ which appear to be appropriate to a person skilled in the art. By contrast, steel and iron have, for example, a density in a range from 7850 kg/m³ to 7870 kg/m³.

According to the invention, it is provided that the fitting unit 12 is produced partially from aluminum. Aluminum has a density of 2700 kg/m³. It is conceivable that the fitting unit 12 is produced entirely from aluminum. In the exemplary embodiment shown in FIG. 1 and FIG. 2, the fitting unit 12 is produced from an aluminum alloy. Specifically, the fitting unit 12 is produced from a high-strength aluminum alloy. For example, it is conceivable that the fitting unit 12 is produced from an aluminum-lithium alloy, such as, for example, Al—Li 2099. In the present exemplary embodiment, the fitting unit 12 is produced from an aluminum alloy, specifically from an aluminum alloy designated as AW7055.

Alternatively, it is conceivable that the fitting unit 12 is produced partially from titanium. Titanium has a density of 4507 kg/m³. It is conceivable that the fitting unit 12 is produced entirely from titanium. It is also conceivable that the fitting unit 12 is produced from a titanium alloy.

A form of the fitting unit 12 shown in FIG. 1 and FIG. 2 is variable. A form of the fitting unit 12 is preferably adapted to particular requirements. The particular requirements result from a particular geometry of a guide rail of a means of transport, for example an aircraft, into which guide rail the fitting unit 12 is inserted in a mounted state. The present exemplary embodiment shows only one possible form of the fitting unit 12. Owing to the fact that the form of the fitting unit 12 is of minor importance for the present invention, it will not be discussed in more detail here.

The fitting unit 12 has a strength of greater than 650 N/mm². Accordingly, the fitting unit 12 is formed from a high-strength material. In the present exemplary embodiment, the fitting unit 12 has a strength of 700 N/mm². Moreover, the fitting unit 12 has an elongation at break of 9%.

FIG. 1 shows—as already mentioned above—the detail of the fitting body 10 in the partially manufactured state. The partially manufactured state is configured as a state of the fitting body 10 and the fitting unit 12 after a first method step of a method for producing the fitting body 10 according to the invention. In the partially manufactured state shown in FIG. 1, the fitting unit 12 has an extruded profile. The first method step of the method for producing the fitting body 10 takes the form of an extrusion method. Accordingly, the fitting unit 12 is produced partially in an extrusion process. It is also conceivable that the fitting unit 12 is produced completely in an extrusion process.

FIG. 2 shows the fitting body 10 according to the invention from FIG. 1 in a manufactured state. By comparison with the partially manufactured state of the fitting body 10 shown in FIG. 1, the fitting unit 12 is milled to its final dimensions. Accordingly, the fitting unit 12 is produced partially in a milling process. As can be seen from FIG. 2, the fitting unit 12 in the manufactured state has six fastening means 14 for fastening the fitting unit 12 in the guide rail (not shown) of the means of transport (not shown). Of the fastening means 14, only three fastening means 14 can be seen in FIG. 2, since the remainder are concealed. Moreover, in FIG. 2, only one of the fastening means 14 is provided with reference signs for the sake of clarity. The fastening means 14 are designed as projections. In addition to providing fastening, the fastening means 14 are intended to allow a sliding movement of the fitting unit 12 in the guide rail. Furthermore, the fitting unit 12 has a fixing means 16. The fixing means 16 is designed as a cutout having a thread and is intended to fix the fitting unit 12 in the guide rail by means of a corresponding fixing means, for example a screw (not shown). Moreover, the fitting unit 12 has a coupling unit 18 which is intended to couple to the fitting unit 12 a further component (not shown), such as, for example, a seat unit and/or a cable for tying down loads, such as, for example, an object. The coupling unit 18 is designed as a cutout.

The method for producing the fitting body 10 according to the invention will be explained below with reference to FIG. 1 and FIG. 2. In the first method step of the method for producing the fitting body 10, the fitting unit 12 is brought into the partially manufactured state already described above. Here, the fitting unit 12 is produced partially in an extrusion process. In order to pass from the manufactured state of the fitting body 10 shown in FIG. 2 to the partially manufactured state of the fitting body 10 shown in FIG. 1, at least one further method step is required. Starting from the partially manufactured state, the fitting unit 12 is milled to its final dimensions by the further method step. Accordingly, the fitting unit 12 is produced partially in a milling process.

### REFERENCE SIGNS

10 Fitting body
12 Fitting unit
14 Fastening means
16 Fixing means
18 Coupling unit

1. A fitting body having at least one fitting unit which comprises, at least to a large part, of a material having a density of less than 7000 kg/m³.

2. A fitting body in particular according to claim 1, wherein the fitting unit comprises, at least partially, an extruded fitting unit.

3. A fitting body according to claim 1, wherein the fitting body comprises, at least partially, an aluminum fitting body.

4. A fitting body according to claim 1, wherein the fitting unit comprises, at least partially, a titanium fitting unit.

5. A fitting body according to claim 1, wherein the fitting unit comprises, at least partially, a milled fitting unit.

6. A fitting body according to claim 1, wherein the fitting unit has a strength of greater than 650 N/mm².

7. A method for producing a fitting body according to claim 1.

8. A method according to claim 7, wherein the fitting unit is produced, at least partially, in an extrusion process.

9. A method at least according to claim 7, wherein the fitting unit is produced, at least partially, in a milling process.

10. A fitting body according to claim 2, wherein the fitting body comprises, at least partially, an aluminum fitting body.

11. A fitting body according to claim 2, wherein the fitting unit comprises, at least partially, a titanium fitting unit.

12. A fitting body according to claim 2, wherein the fitting unit comprises, at least partially, a milled fitting unit.

13. A fitting body according to claim 2, wherein the fitting unit has a strength of greater than 650 N/mm².

14. A method for producing a fitting body according to claim 2.

15. A fitting body according to claim 3, wherein the fitting unit comprises, at least partially, a titanium fitting unit.

16. A fitting body according to claim 3, wherein the fitting unit comprises, at least partially, a milled fitting unit.

17. A fitting body according to claim 3, wherein the fitting unit has a strength of greater than 650 N/mm².

18. A method for producing a fitting body according to claim 3.

19. A fitting body according to claim 4, wherein the fitting unit comprises, at least partially, a milled fitting unit.

20. A fitting body according to claim 4, wherein the fitting unit has a strength of greater than 650 N/mm².
